(19) United States
(12) Patent Application Publication
(10) Pub. No.: US 2013/0268380 A1
(43) Pub. Date: Oct. 10, 2013

(54) METHOD FOR ACCESSING POINT-OF-SALE TRANSACTION INFORMATION OVER A NETWORK

(71) Applicants: ANDREW HUSSIE, Amherst, MA (US); BYRON HUSSIE, Watertown, MA (US)

(72) Inventors: ANDREW HUSSIE, Amherst, MA (US); BYRON HUSSIE, Watertown, MA (US)

(21) Appl. No.: 13/442,424

(22) Filed: Apr. 9, 2012

(51) Int. Cl. G06Q 20/20

(52) U.S. Cl. 705/21

(57) ABSTRACT

A system for capturing and storing customer transaction information includes a point-of-sale device for capturing information about items purchased by the customer, a dispenser for notifying the customer of an code identifying the transaction and a network address where the customer can go to view the transaction information, and a device connected over a network to the point-of-sale device for storing the customer transaction information. The customer uses the identifying code and the network address to access their transaction information without having to authenticate with the device associated with the network address, and the transaction information does not include any customer specific information.

### BACKGROUND

1. Field of the Invention

The present disclosure relates generally to systems that collect and store purchase transaction information, and specifically to a point-of-sale system that operates to reduce or eliminate the need for a paper receipt.

2. Background

Transaction information relating to items being purchased from a vendor at a point-of-sale (POS) is typically captured or entered into POS device, such as an electronic cash register where it can be stored, at least temporarily, pending the dispensing of a paper receipt to the purchaser of the items, and pending any further distribution of the information within a network to which the POS device is connected. Transactional information printed on a paper receipt can include such information as a description of the item(s) being purchased, an inventory code identifying the items, whether one or more of the same item is purchased, the total cost of the items purchased, the date of the transaction and a transaction code, and whether cash or some form of credit or debit is used to purchase the items. If the form of payment is either credit or debit, then some information relating to the credit or debit account can be included in the receipt. This transaction information can then be sent to a local or remote device connected to the network, such as a server, which maintains a store of the transactional information for one or more vendors. Such point-of-sale (POS) retail systems that dispense a paper receipt comprising transactional information have been in use for many years.

3. Discussion of the Prior Art

Recently, with the increased focus on environmental consciousness, and the proliferation of portable memory and smart, mobile communication devices, paperless receipt POS retail systems have come into use. These paperless systems mitigate both the paper waste associated with a paper receipt, and they provide an increased level of security not realized with the paper receipt method.

FIG. 1 is a diagram illustrating functional elements comprising paperless receipt system 10. System 10 is shown to include three locations, location A, location B and location C. Location A is comprised of two point-of-sale devices, POS 11 and POS 12 and a switch/router 15, with each of the POS devices being connected over a local network to the router 15. The POS devices can be any electronic device capable of receiving purchase transaction information either from a scanning device or manually by an operator. The purchase transaction information, or simply purchase information, can include, but is not limited to, a description of the item or items purchased, an inventory code associated with the item, the number of items purchased, the cost of each item, the purchase date, method of purchase (cash, credit or debit), and any account numbers or partial account numbers associated with a credit or debit card. This purchase information can be temporarily stored at each POS device for delivery to a customer at location A or B for instance, or which the customer can access at a location C, which is connected over a network 16 (such as the Internet) to location A. A receipt dispenser associated with each of the point-of-sale devices al location A and B can operate to receive the transaction information temporarily stored by each POS device, and dispense/transmit the transaction information to a customer. Depending upon the type of device that the customer possesses to receive the transaction information, the information can be transferred by the receipt dispenser to the customer over a wireless connection or over a physical, wired connection. The POS devices can also send the transaction information to the router 15, which can temporarily store the information or immediately send the transaction information to a remote server 14 at location C. The remote server 14 can include a database management system which creates a file, comprising the transaction information sent to it by router 15, and store the file in the purchase transaction database associated with the server 14. Transaction information stored in the database can be accessed, subject to certain pre-registration requirements, over a network (Internet for instance) by a customer in order to view and download their transaction information.

Many variations on the paperless receipt system described with reference to FIG. 1 can be implemented. One paperless receipt system requires that customers pre-register with a service (running on server 14 for instance) that delivers their receipt electronically. In this case, an individual who purchases the product pre-registers with the service. This pre-registration can include among other things providing the service with such personal information as credit card information and an electronic mail address. After the purchase transaction is completed, the service can then send an electronic copy of the purchase information to the purchaser's electronic mail address. Another paperless receipt system also requires the purchaser to pre-register for the paperless receipt service, and after registering is provided with a password that is used to access a secure site to review their purchase information.

U.S. patent application Ser. No. 13/156,599 describes a method for generating electronic receipts from print data in which a customer can insert an electronic storage device into a green receipt dispenser to intercept print data prior to its being printed on paper. The print data is converted into electronic form and stored in the electronic storage device where it can be later accessed for view by the customer.

U.S. patent application Ser. No. 12/150,355 describes an electronic receipt system that captures electronic receipt information and transmits it to a membership or subscriber based web-site, where it can then be viewed by the subscriber or member by logging into the site. U.S. patent application Ser. No. 12/573,872 describes a process for paperless receipts in which receipt information can be either loaded from the POS device into a thumb drive or sent from the device to an email address. U.S. patent application Ser. No. 11/146,478 describes a method for the dissemination of paperless transaction receipts in a non-networked environment in which receipt information is wirelessly transmitted to a portable device that is held proximate to sales equipment transmitting the information.

All of the prior art described above requires one or more of the customer (purchaser of items) pre-registering with a service that delivers purchase transaction information at the point-of-sale or over a network connection, the point-of-sale system collecting and distributing personal payment (financial institution/partial account number) information, customer receiving the transaction information at the point-of-sale from a special purpose electronic receipt device.

### 4. BRIEF DESCRIPTION OF THE DRAWINGS

The present invention can be best understood by reading the specification with reference to the following Figures, in which:

FIG. 1 illustrates a prior art paperless receipt transaction system.

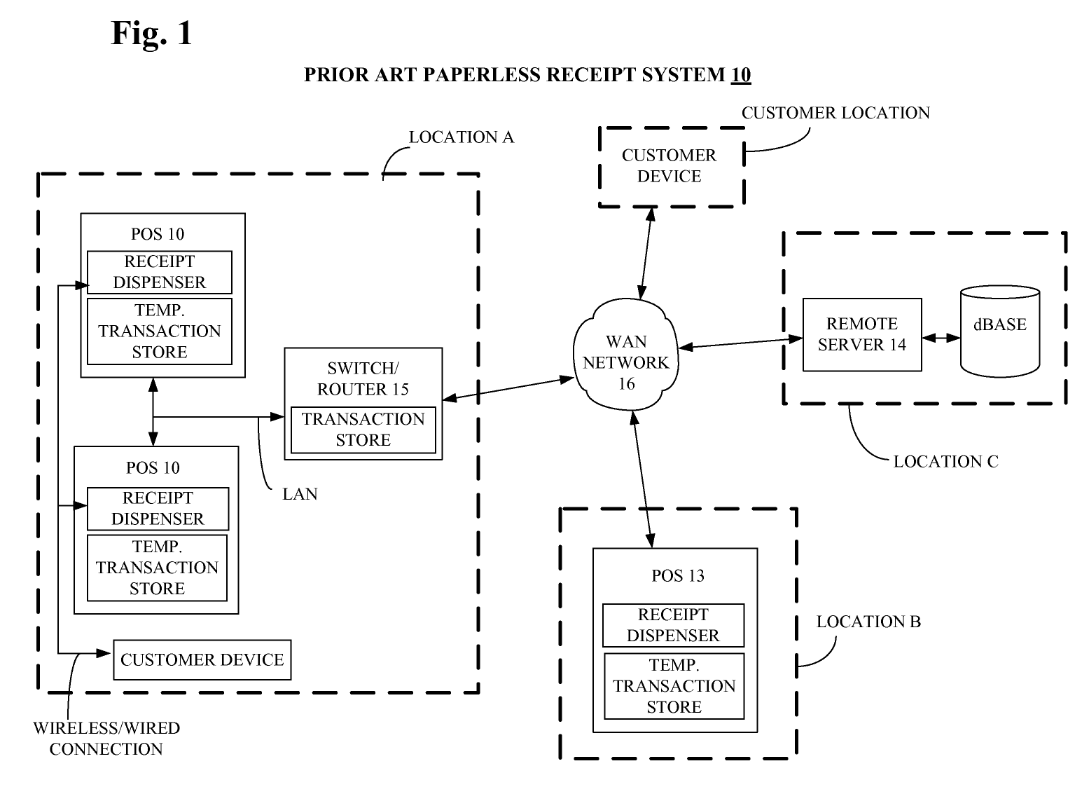

FIG. 2 is one embodiment of a paperless receipt transaction system according to the invention.

FIG. 3 is another embodiment of a paperless receipt transaction system.

FIG. 4 is another embodiment of a paperless receipt transaction system.

FIG. 5 is a diagram showing functionality comprising a point-of-sale device.

FIG. 6 is logical flow diagram of the process of one embodiment of the invention.

### 5. DETAILED DESCRIPTION

While prior art systems for dispensing paperless receipts to customers at a point-of-sale device (POS), or systems for permitting customers remote access to paperless receipts generated at a POS certainly mitigate the waste associated with a paper receipt, these systems do not fully protect customers personal information, such as financial institution information, account numbers, and electronic mail addresses, and these systems typically require that customers pre-register in some manner prior to receiving the transaction information, or are limited to the customer receiving transaction information at the POS. Therefore, it is desirable that only non-private transaction information gathered at a POS device is available to a customer in paperless form, and that this transaction information is easily accessible over a wide area network (WAN) to the purchaser associated with the transaction without complicated security procedures.

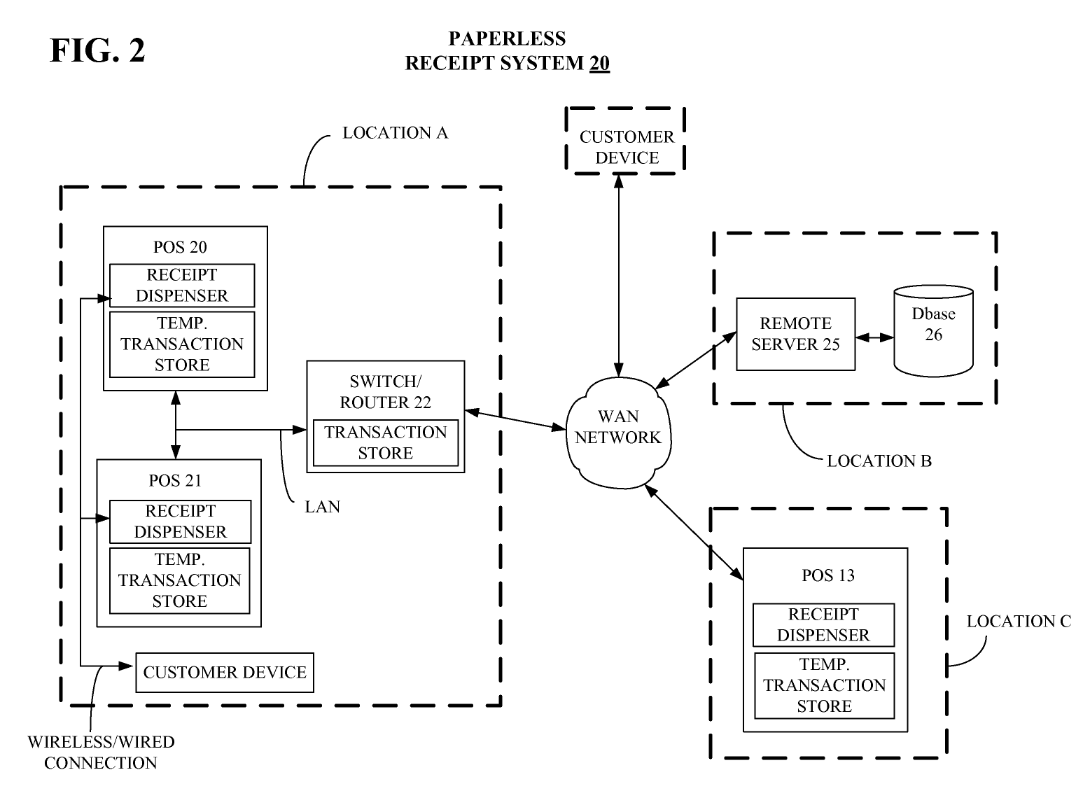

FIG. 2 illustrates an embodiment of a paperless receipt system 20 that stores POS purchase transaction information either locally or remotely, and which operates to permit a customer to access the purchase transaction information over a WAN without the need to pre-register with the system. The stored purchase transaction information does not include any customer specific information, but can, among other things, include the identify of items that were purchased by the customer during a particular purchase transaction. Other information that can be stored in the system 20 can include the date of the purchase and the store at which the purchase was made. However, with the exception of personal information specifically associated with a customer, it should be understood that the stored transaction information accessible by the customer is not only limited to the transaction information listed here.

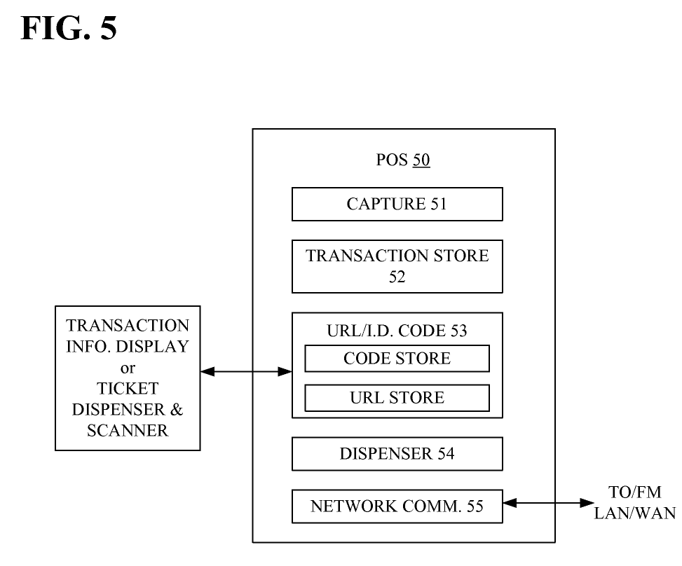

The paperless receipt system 20 of FIG. 2 is comprised of three separate locations, location A, location B and location C, each of which can be geographically separated from the other by a distance or which can be co-located proximate to each other. Regardless, locations A, B and C can be linked to each other over a network (local of wide area network), and transaction information can be transmitted from POS devices 20 and 21 at location A and POS device 27 at location C to a server 25 at location B. Each of the locations A and C can include devices under the control of a single vendor, or each of the locations can include devices under the control of separate vendors, and the system 20 can include more than two vendor locations or it can include only one vendor location. The POS devices at locations A and C can capture purchase transaction information for temporary storage at the POS device prior to it being sent, over a local network, to the switch or router device 22 also included in location A. When a complete set of purchase transaction information is captured (i.e., when items purchased by a customer are entered into the system) by one of the POS devices at location A, transaction identification information can be dispensed by the POS device to a customer, which the customer can later use to access the information over the WAN. The transaction identification information can comprise a network address (URI or URL) and a transaction code (alpha numeric code, key words, or other easily remember form of transaction identification) and this information can be dispensed to the customer either visually on a digital display associated with the POS device, it can be dispensed to a customer's electronic device (smart phone, pad, memory), or it can be included on a small, pre-printed ticket that is dispensed to the customer. In any case, the POS device generates the identification information and associates this information with a set of transaction information most recently captured to form a packet of transaction information which can then be sent to the network address assigned to the set of transaction information, which in this case is the remote server 25 at location B for storage. The method for generating the transaction identification information and assigning it to a set of transaction information will be discussed later with reference to FIG. 5.

With continued reference to FIG. 2, the router/switch 22 generally operates to receive the packet of transaction information, and either temporarily store the information for periodic transmission to the remote server 25, or doesn't store it and immediately transmits it to the remote server 25. The remote server 25 at location B can include a database management system, and generally operate to receive the packet of transaction information sent to it from the switch/router 22, organize this information into one or more files identified by the transaction identification information, and send the file(s) for storage to a database 26 associated with it. Using the network address of the remote server 25 and the transaction identification code, dispensed by the POS device, the customer can access the set of transaction information stored at location B in the database 26 without having to pre-register or be authenticated to access the information stored in the database maintained by the server 25. As the system 20 of FIG. 2 does not capture and store any transaction information that is specific to a customer (account number or payment method for instance), the transaction information can be stored in the database 26 with only minimal security precautions, which in this case is a transaction identification code. The transaction identification code associated with each file stored in the database 26 can be globally unique in the system 20, or it can be unique to each of two or more vendors who are connected to the system 20 and store transaction information therein.

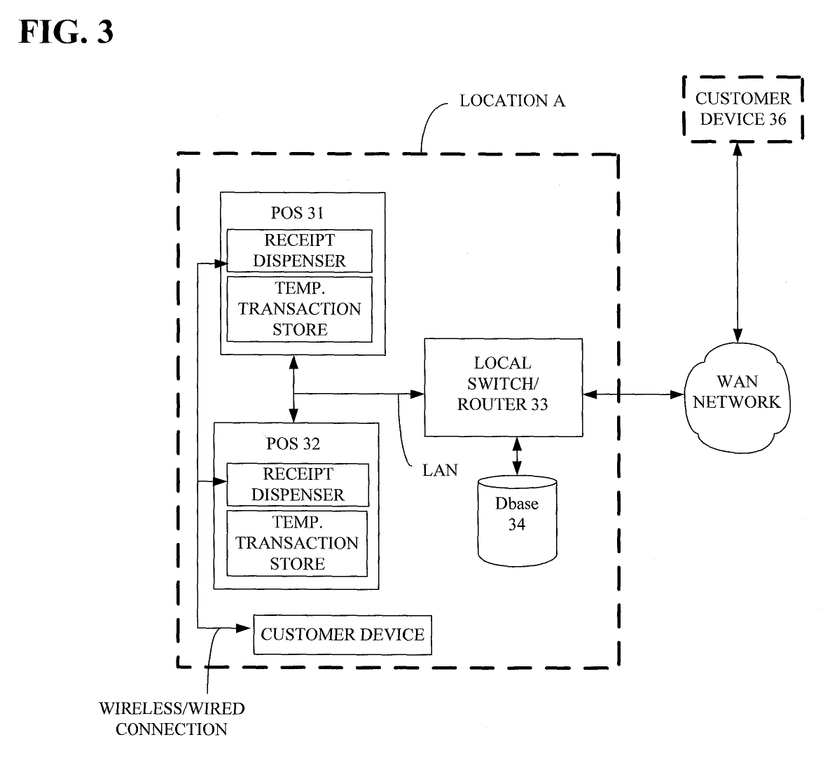

FIG. 3 illustrates an embodiment of a paperless receipt system 30 that is comprised of a single location A connected to a WAN network 35. In this embodiment, as with the embodiment described with reference to FIG. 2, each of the POS devices at location A can capture and temporarily store the purchase transaction information, however, in contrast to the embodiment of FIG. 2, the transaction information captured by the POS devices in this embodiment is not sent to a remote server, such as server 25 of FIG. 2, for storage. Rather, this transaction information is stored in a server 33 that is local to, in this case, POS devices 31 and 32. The local server 33 can include a DBMS (not shown) and generally operate to maintain files, comprising sets of purchase transaction information, in a database 34. As with the system 20 of FIG. 2, each of the sets of transaction information are assigned transaction identification information (URL and code) by the POS device that captures the information. Similar to the embodiment of FIG. 2, each of the POS devices in system 30 can dispense a network address and a transaction identification code to the customer at the time the items associated with the transaction are purchased. The network address, in this case, can be the address of the local server 33, and this network address can be used in conjunction with the transaction identification code to access the customers transaction information stored in a file in the database 34. As with the system 20 embodiment described with reference to FIG. 2, system 30 does not store any customer specific information in the database 34 and there is no need for the customer to pre-register or to authenticate with the server 33 in order to access their transaction information. Although the system 30 in FIG. 3 is only shown to include one POS location, which is location A, more than one location can included in the system 30, each being connected to the network 35.

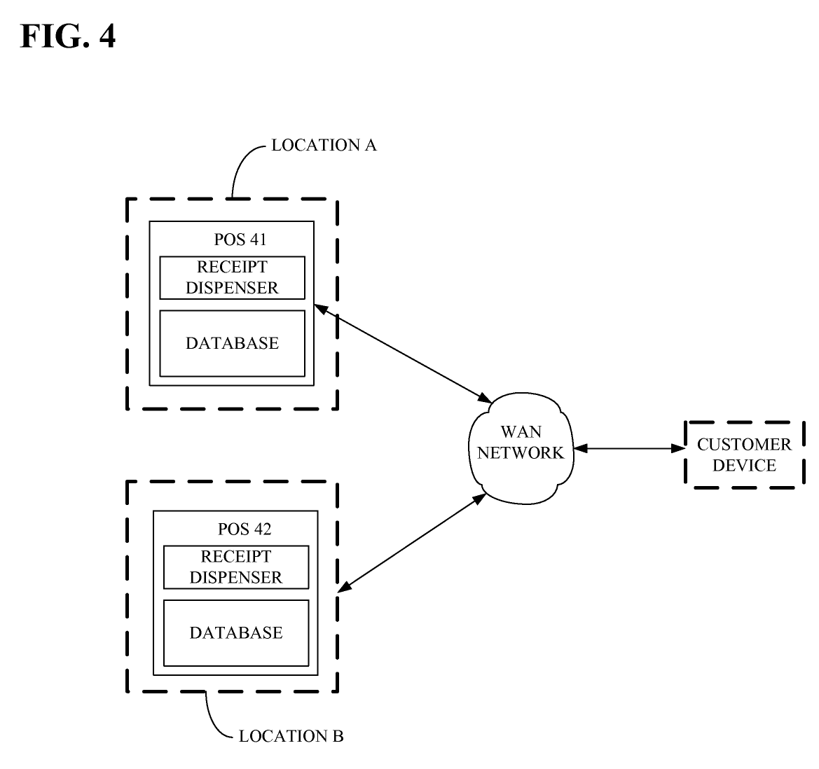

FIG. 4 illustrates an embodiment of a paperless receipt system 40 that is comprised of a location A and a location B, each linked to a WAN network 43. In this embodiment, each location is shown to include one POS device, but each location can include more devices, and each POS device, 41 and 42, is configured to store purchase transaction information locally on that device. In this case, each device has a unique network address that a customer can use to access transaction information stored on the device. As with the embodiments described earlier with reference to FIGS. 2 and 3, each POS device comprising system 10 includes functionality for dispensing both a network address and a transaction identification code to a customer that they can then use to later access, over the WAN 43, their transaction information stored at the POS device. And again, as with the earlier embodiments, system 40 does not capture and store any customer specific/personal information and does not require a customer to pre-register or to authenticate with the system 40 in order to access their transaction information over the WAN 43.

FIG. 5 is a diagram showing functional elements comprising a POS device 50, such any of the POS devices described with reference to FIGS. 2-4. As described earlier, the POS device can be any type of electronic device configured to be connected to a network (LAN or WAN) and to capture transaction information associated with the purchase of items by a customer at the point-of-sale location. The POS device 50 is comprised of capture functionality 51 to capture information associated with a customer purchase transaction. This information can include, but is not limited to, such things as the product code used for the purpose of tracking inventory, it can include the purchase price of the items, the number of similar items purchased, the method of payment (cash, credit, debit) and at least a partial account number, and the date that the transaction is completed. This information can be captured by a scanning mechanism (UPC scanner) or it can be manually entered and captured by the POS device. Once captured, the purchase transaction information can be temporarily stored in a transaction store 52, which can be any type of digital memory device (dynamic or static memory or disk) prior to being assigned a URL and transaction identification code. The POS 50 also comprises a URL and transaction identification code function 53 which operates to assign a URL and unique code to each set of transaction information temporarily stored in the transaction store 52. The assignment function 53 can include a store of transaction identification codes and a store of URLs. Typically, the same URL can be assigned to each set of transaction information, but in the event that the transaction information can be stored in one or several network addresses in a system, the URL store can include a plurality of URL codes. The codes stored in the assignment function 53 can be automatically generated by the function each time a customer transaction is completed, or they can be detected on a ticket that is dispensed to the customer. A paper ticket with a transaction identification code printed on it can be scanned as it is dispensed to the customer, and the code can be temporarily stored in memory associated with the assignment function 53. As mentioned earlier, each transaction identification code can be unique to each purchase transaction, at least with respect to a particular URL. The POS device 50 is also comprised of a dispenser function 54 which generally operates to convey to the customer in some manner the URL and code assigned to the set of transaction information associated with a single customer transaction. The URL and code can be presented to a customer for viewing on any type of digital display linked to the dispenser 54 or the dispenser function 54 can control a mechanism to dispense a paper ticket, including a URL and code, to a customer. Regardless of the manner in which the URL and code are dispensed to a customer, no transactional information is dispensed to the customer at the POS location, and no personal information is captured at the POS device for storage in a transaction database that is accessible by a customer.

In operation, after the set of transaction information is captured and stored in the store 52, the assignment function 53 can assign a URL and either generate and assign a code to the transaction information or detect and assign a code to the transaction information, and then dispense the URL and code to the customer. At some point subsequent to the POS device 50 storing the transaction information in store 52, this information, along with the URL and code, is sent to a network communication function 55 which operates to place it into a form suitable for transmission over a local network to a server or over a WAN to a remote server for storage in a transaction database for access by a customer. Alternatively, the transaction information, along with the URL and code, can be stored permanently on the POS device 50 where is can be accessed by a customer.

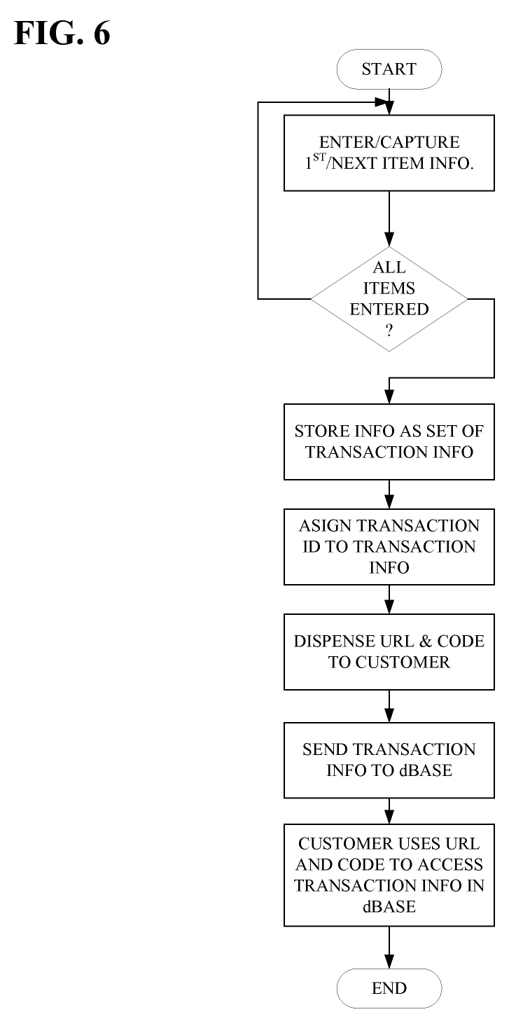

FIG. 6 is a logical flow diagram of one embodiment of the invention. In step 1 of the process, information corresponding to a first or next item purchased by a customer is captured by a POS device, such as the POS device 50 in FIG. 5. This information can include, but is not limited to, such things as the product code used for the purpose of tracking inventory, it can include the purchase price of the items, the number of similar items purchased, the method of payment (cash, credit, debit) and at least a partial account number, and the date that the transaction is completed. After information corresponding to the first item is captured, the POS device can determine that the purchase transaction is completed or not, and if not the process returns to Step 1. If the POS device determines that the transaction is completed, then the process proceeds to Step 3, where the product code and/or product description and possibly the purchase date is temporarily stored at the POS device as a set of transaction information. In Step 4, a URL and a transaction identity code are assigned to the temporarily stored set of transaction information, and in Step 5 the URL and transaction identity code is dispensed to the customer responsible for purchasing the items. The URL and code can be dispensed electronically or on a small piece of paper/ticket that the customer can retrieve and take with them. This information can be dispensed electronically to the customer either via a digital display device connected to the dispensing functionality, or it can be dispensed to an electronic device (smart phone or thumb drive for instance) owned by the customer. In Step 6, the POS device can then transmit a packet comprising the set of transaction information and associate code over a network (LAN or WAN) to the URL assigned to the transaction information. The packet transmitted by the POS device is received by a server connected to the network with the network address specified by the URL, and the server, running a DBMS, creates a file that is identified by the code identifying the set of transaction information and stores the file in a transaction database. At some point subsequent to the completion of the transaction, the customer is able to use the URL and identifying code dispensed to them at the point-of-sale to access and view their transaction information stored in a transaction information database.

As described earlier with reference to FIGS. 2-4, the URL dispensed to a customer can be the network address of a server that is remote with respect to a POS device that dispenses the URL, it can be the network address of a server that is local to the POS device or it can be the network address of the POS device. Remote in this context means that the server and the POS device can only communicate with each other over a WAN, such as the WAN in FIG. 2.

The forgoing description, for purposes of explanation, used specific nomenclature to provide a thorough understanding of the invention. However, it will be apparent to one skilled in the art that specific details are not required in order to practice the invention. Thus, the forgoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

We claim:

1-18. (canceled)

19. A method of remotely accessing point of sale customer transaction information stored on a computational device connected to a network, comprising:
a point of sale device having specially designed computer instructions that when executed cause it to capture information corresponding to items purchased by a customer and to capture customer specific information relative to a method of payment;
the point of sale device creating a set of customer transaction information comprising the information corresponding to the purchased items but not comprising the customer specific information;
the point of sale device selecting a unique code from a list of unique codes and assigning it to the set of the customer transactional information, and sending the set of customer transactional information and the assigned unique code as a coded customer transaction message over the network to a network address associated with the computational device connected to the network for storage in a computer readable file identified by the assigned code, the computational device not being a customer device;
the point of sale device dispensing to the customer at the point of sale the code uniquely identifying the computer readable file associated with the customer transaction information and the network address of the computational device to which the transaction information is sent; and
the customer using the network address to access the computational device and using the identifying code to access the set of customer transaction information stored in the file at the computational device without the customer being authenticated with the computational device.

20. The method of claim 19, wherein the computational device connected to the network is a network server.

21. The method of claim 20, wherein the network server comprises a database management system and computer readable memory means for storing the computer readable file in a database.

22. The method of claim 19, wherein the point-of-sale device is an electronic cash register or a general purpose computational device.

23. The method of claim 19, wherein the set of customer transaction information comprises one or more of a listing of purchased items, the price of each purchased item, the purchase date, and the identity of the vendor at the point-of-sale.

24. The method of claim 19, wherein the information specific to the customer comprises one or both of a payment method and account number.

25. The method of claim 19, wherein the assigned identifying code comprises one or more of a UPC code, a number code, a letter code, and a combination number and letter code.

26. The method of claim 19, wherein the computational device to which the transaction information is sent is connected to either a local area network or a wide area network.

27. The method of claim 19, wherein the identifying code is dispensed electronically or physically to the customer by the point of sale device.

28. A system for remotely accessing a point of sale customer transaction information stored on a computational device connected to a network, comprising:
a point of sale device and an associated dispenser device connected to a network, the point of sale device operating to capture information relative to items purchased by a customer and to capture customer specific information relative to a method of payment, creating a set of customer transaction information comprising information relative to one or more items purchased by the customer but not the customer specific information, assigning an identifying code to the set of customer transaction information, sending the set of customer transaction information and the assigned identifying code as a coded customer transaction message over the network to a network address associated with a computational device connected to the network, the computational device not being a customer device, for storage in a computer readable file identified by the assigned code, the dispenser device notifying the customer of the network address and the identifying code; and
the customer computational device connectable to the network into which the customer enters the network address and the identifying code to access the customer transaction information stored in the computer readable file at the computational device without authenticating with the computational device.

29. The system of claim 28, wherein the computational device connected to the network is a network server.

30. The system of claim 29, wherein the network server comprises a database management system and computer readable memory means for storing the computer readable file in a database.

31. The system of claim 28, wherein the point-of-sale device is an electronic cash register or a general purpose computational device.

32. The system of claim 28, wherein the set of customer transaction information comprises one or more of a listing of purchased items, the price of each purchased item, the purchase date, and the identity of the vendor at the point-of-sale.

33. The system of claim 28, wherein the information specific to the customer comprises one or both of a payment method and account number.

34. The system of claim 28, wherein the assigned identifying code comprises one or more of a UPC code, a number code, a letter code, and a combination number and letter code.

35. The system of claim 28, wherein the networked computational device to which the transaction information is sent is connected to either a local area network or a wide area network.

36. The system of claim 28, wherein the identifying code is dispensed electronically or physically to the customer by the point of sale device.
